(19) United States
(12) Patent Application Publication
(10) Pub. No.: US 2015/0148722 A1
(43) Pub. Date: May 28, 2015

(54) DEVICE AND METHOD FOR MASSAGE THERAPY

(71) Applicant: Maxine McLean, Toronto (CA)

(72) Inventor: Maxine McLean, Toronto (CA)

(21) Appl. No.: 14/551,259

(22) Filed: Nov. 24, 2014

Related U.S. Application Data
(60) Provisional application No. 61/908,241, filed on Nov. 25, 2013.

(51) Int. Cl. A61H 15/00

(52) U.S. Cl. CPC A61H 15/0092; A61H 2015/0064
USPC 601/131

(57) ABSTRACT

The present concept is a device and method for providing massage which addresses the problem of practitioner injury while at the same time allows for the provision of a better massage. The device allows a massage practitioner to deliver to a recipient a spectrum of beneficial physical contacts in a way that spares the provider's hands and arms the repetitive strain that tends to lead to injury or early retirement. The method describes a technique whereby a practitioner delivers a treatment similar to a traditional massage but firstly necessitates less pressure to be exerted by the provider, and secondly delivers a reciprocal hand massage to the provider, while thirdly provides for a largely uninterrupted delivery of physical contact to the recipient.

This application claims priority from prior provisional application No. 61/908,241, filed on Nov. 25, 2013 by Maxine McLean under the title: DEVICE AND METHOD FOR MASSAGE THERAPY

### FIELD OF THE INVENTION

The application discloses a device and method for massage therapy, as performed on a human massage recipient by a human massage provider.

### BACKGROUND OF THE INVENTION

Massage is an effective way of relaxing the human body and promoting physical and mental health. However, massage by hand is difficult and tiring and leads to repetitive-strain injuries of the hands and arms of massage practitioners.

Other massage devices have been designed. One such spherical device was designed to deliver vibrations (U.S. Pat. No. 6,432,071 B 1, publication date—Aug. 13 2002, Wen Sen Hsieh). Another device involved two balls connected by a cord (US 20030040688 A1, publication date—Feb. 27, 2003, Dirk Bauer). Other devices have a spherical component mounted to a mounting body (for example, US 20130190664 A1, publication date—Jul. 25, 2013, Ronald B. Johnson). Another similar device is motor-driven (U.S. Pat. No. 6,102,875 A, publication date—Aug. 15, 2000, Rick E. Jones). Another is designed to treat ‘trigger points’ (U.S. Pat. No. 7,458,945 B2, publication date—Dec. 2, 2008, Cheryl E. Zemont). Another is designed to retain and deliver heat (WO 2006022622 A1, publication date—Mar. 2, 2006, Michael A. Cohen). Yet another is designed to allow a user to deliver deep-tissue massage to him- or herself (US 20110071446 A1, publication date—Mar. 24, 2011, Stuart Citrin).

A general shortcoming is that none of these devices is as simple or easy to use as the present invention.

A basic shortcoming of these devices is that they have been designed with a narrow and specific functionality in mind.

The benefits of the present invention is that it will give the recipient a deep massage with their clothes on as they lay under the warmth and comfort of a blanket. The blanket should be a lightweight velour type material. The advantages are:

1) Delivery of a massage that is non-invasive.

2) Provides warmth to the recipient since the individual receiving the message remain in their own clothes during the message.

3) Prevent possible exploitation therefore making it ideal for all ages. It is also teachable in a co-ed environment and

4) Allows for privacy sensitivity.

Another shortcoming of these devices is that most involve multiple inter-connected parts and/or a motor-driven mechanism; these will be prone to wear-and-tear and breaking. Some depend on their ability to store and release heat or other agents; these will be prone to functional compromise with the passage of time and usage. All of these more-complicated devices will be more difficult to keep clean.

None of these other inventions conceives of device and method as two parts of a coherent whole.

A significant shortcoming of these other inventions is that none of them takes the better health of both massage provider and massage recipient as the main object of the invention.

Moreover, none of these other devices allows a massage provider to deliver a massage in a fashion that preserves the beneficial human relationship between traditional provider and massage recipient—uninterrupted by the application of mechanical vibration or other motor-driven effect, or by the interposition of a cord or grip or mounting device.

A shortcoming of these other devices is that none of them preserves the healing function of the practitioner, and not merely the practice. The present invention, by way of contrast, attains a sort of “laying on of hands,” but with the interposition of a simple device that modulates the intimacy of the human touch in such a way as to permit the massage provider to deliver massage therapy to regions of the recipient's body, the treatment of which can be anxiety-provoking for certain people. The device nonetheless allows the massage provider to identify areas of muscle tightness, stress nodules, tissue indurations, and other abnormalities in muscles, tendons and skin.

The present invention is designed to improve massage therapy generally, for both provider and recipient. Properly performed, massage therapy according to this invention will improve venous and lymphatic circulation, enhance the elimination of toxins, and clear the energy pathways of the recipient's body. It will, moreover, deliver a reciprocal massage to the hands of the practitioner, rather than repetitive strain.

### SUMMARY OF THE INVENTION

The present invention is intended to offer a set of massage tools and a method for using those tools that solves the problem of practitioner injury and shortened career, and further allows for the provision of better (more variable, more thorough, more responsive) massage. This invention, in various embodiments, will allow a massage practitioner to deliver a spectrum of physical contacts (in varying size and consistency) in a way that spares the provider's hands and arms the repetitive over-work and strain that tends to lead to early retirement.

The invention set out herein is embodied in a set of tools, and a method of using the tools. The tools are variable in size, shape, weight, texture, and consistency (see FIGS. 6-8). The method according to which the tools are deployed is also variable. Moreover, the method and tools can be employed in pursuit of both therapeutic and pleasurable ends.

In an exemplary embodiment of the invention, the user of the tools is a massage practitioner. The massage recipient requires massage therapy to treat, for example, neck and back muscle tension. Alternatively, two persons take on the roles of massage provider and massage recipient in turn, and the object of the ‘massage’ is simple physical pleasure. In another alternative, there is only one user of the tools, who is both provider and recipient.

Tools

In a basic embodiment, the tools are symmetrical, three-dimensional, geometric solids, made of various materials. In alternative embodiments, the tools incorporate mechanisms to allow them to deliver vibrations to the recipient body, or they incorporate certain grips, which allow the practitioner to vary her technique in different ways. Illustratively, in one inventive embodiment, the tools are used as to deliver physical pressure to a recipient's soft tissues. An aspect of the tools is that they sit in the palm of the hand. Other aspects of the tools are their size, shape, texture and consistency. The massage provider can use these aspects to control the focus and quality of the touch. Another aspect of the tools is that they necessitate the user to exert less force than she would need to with existing tools or instruments.

Method

In a preferred embodiment, the method describes a technique whereby a practitioner, by rolling the massage balls between her own palms and the physical body of her subject (see FIG. 5), delivers a ‘treatment’ akin to that delivered by the direct hand-to-body contact method of a traditional masseuse but necessitating less pressure to be exerted by the massage provider. The method described in this invention has the advantages of (1) sparing the hands and wrists of the practitioner the repetitive gripping and flexing that puts excessive stress and strain on small muscles and tendons; (2) delivering a reciprocal hand massage to the practitioner; and (3) delivering a largely uninterrupted physical contact to the massage recipient, rather than the traditional series of discrete points of pressure achieved by pinching, kneading or chopping.

The technique can be adapted by the provider. The provider can apply greater or lesser pressure, by simply adjusting her body weight and centre of gravity. The provider can adjust the size of the circles of pressure traced on the surface of the physical body of the recipient. The provider can adjust the rate of linear ‘travel’ of the focus of the massage treatment from one area of the recipient's body to the next.

In alternative embodiments of the method, the provider can choose to deliver pressure in a zig-zag (or other) pattern, rather than in circles. The provider can even choose to deploy the tools in a hammer-like fashion, rather than by continuous pressure.

Moreover, as mentioned above, the tools can be varied in size, texture, weight and consistency, which variation can be used by the provider to accentuate or modify adjustments in technique.

The present concept is a method for massage therapy which includes

a) Choosing a massage ball of pre-selected size and weight;

b) Use the massage ball by placing the ball between the area to be massaged; and the palm of hand;

c) Pushing the ball into the area to be massaged with the palm of a hand and moving the ball in a circular motion.

Preferably wherein Step A is placed with Step AA as follows:

AA) Choosing a massage ball from among balls having a diameter for about 2.0 cm to 15 cm and a pre-selected weight.

Preferably wherein Step A is replaced with Step AA as follows:

AA) Choosing a massage ball from among balls having a weight from about 10 grams to 200 grams and a preselected diameter.

Preferably wherein Step A is replaced with Step AA as follows:

AA) Choosing a massage ball from among balls having a diameter for about 2.0 cm to 15 cm and a pre-selected weight, choosing a massage ball from among balls having a weight from about 10 grams to 200 grams and a pre-selected diameter.

Preferably further including the Step a′ and a″ replacing step a as follows:

a′) select an area to be messaged;

a″) choose a massage ball of pre-selected size and weight depending upon the area to be messaged.

Preferably further including the step a″′ after step a″ as follows:

a″′) choose a ball having a diameter greater than 5 cm and a weight greater than 60 grams, for massage of the back.

Preferably including the step a″′ after step a″ as follows:

a″′) choose a ball having a diameter less than 5 cm and a weight less than 60 grams for massage of the areas chosen from among neck, face, hands, and feet.

Preferably including the Step a′ and a″ replacing step a as follows:

a′) select a clothed area to be messaged;

a″) choose a massage ball of pre-selected size and weight depending upon the clothed area to be messaged, wherein message takes place over the clothing;

### DESCRIPTION OF THE DRAWINGS

The drawings included illustrate the device in various embodiments, and the method of employing the device generally.

FIG. 1 shows an exemplary embodiment of the device as a spherical massage ball.

FIG. 2 shows the device as a uniform polyhedron.

FIG. 3 shows the device as an ellipsoid solid.

FIG. 4 shows the device in a rope-shaped embodiment.

FIG. 5 is a representation of the basic method.

FIG. 6 shows sizes and weights.

FIG. 7 shows consistency.

FIG. 8 shows texture.

### DETAILED DESCRIPTION OF THE PREFERRED EMBODIMENTS

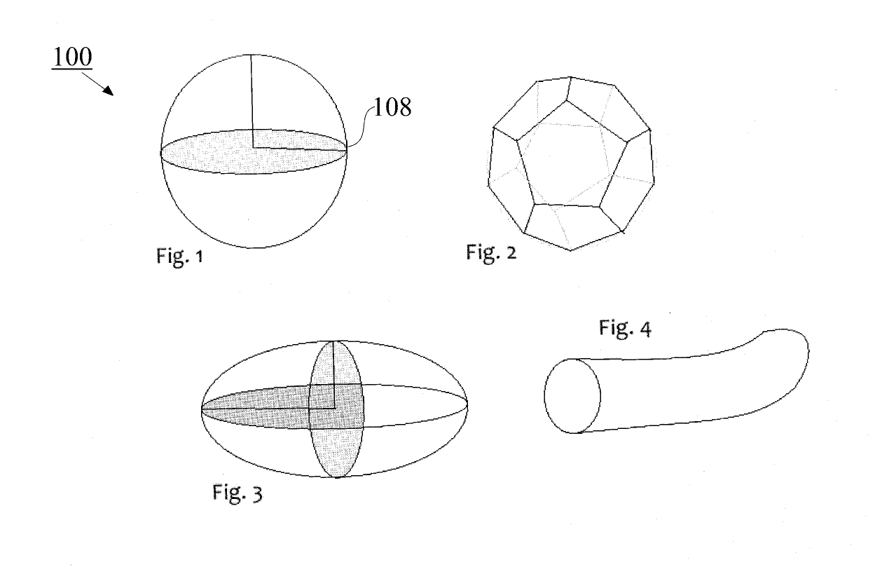

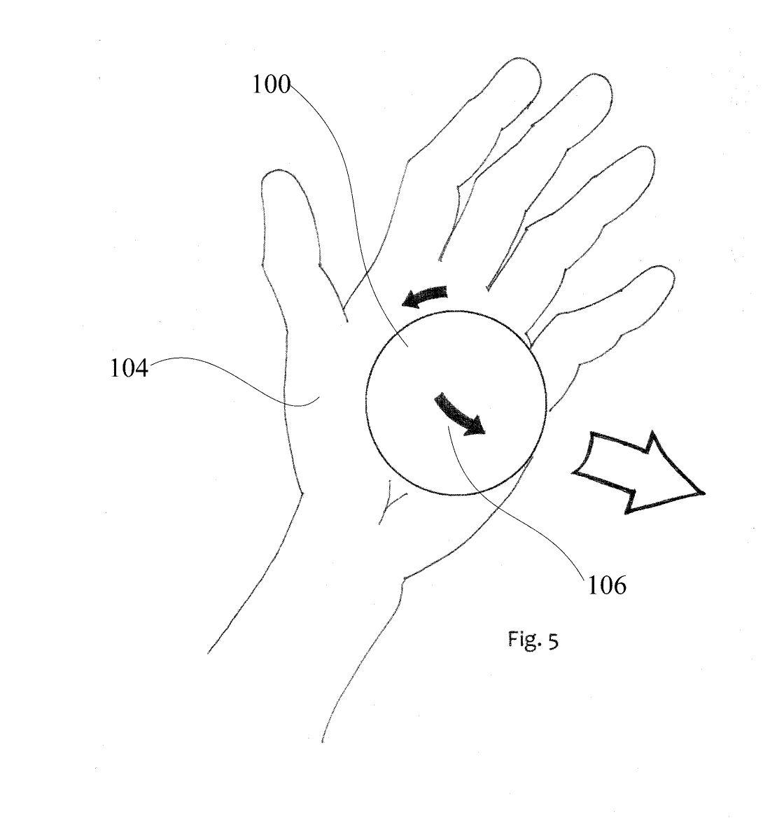

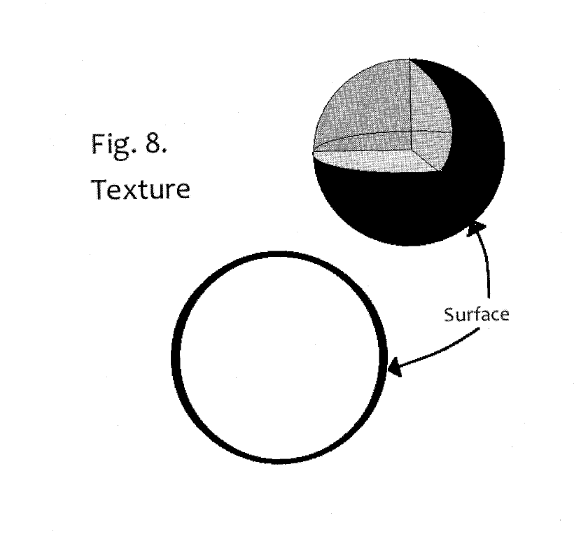

In an exemplary embodiment the tools are spherical (see FIG. 1). Some massage balls will have smooth surfaces; others will have ridged or pebbled surfaces (see FIG. 8). In alternative embodiments, the tools will be sphere-like: for example, uniform polyhedron or regular dodecahedron (see FIG. 2).

In another alternative, the massage tools are not spheres or sphere-like, but are oval or ellipsoid-solid shapes (see FIG. 3). In yet another alternative, the massage tools are not balls, but are rope-shapes (see FIG. 4), or bean-bags.

In the preferred embodiment, the massage tools come in sets of two. A full series of tools will be composed of 14 balls (seven sets of two). The two balls in each set are the same—in size and weight, surface material and consistency. However, as noted above, across the several sets of a series, the tools can vary in those same characteristics—size, texture and consistency being especially important.

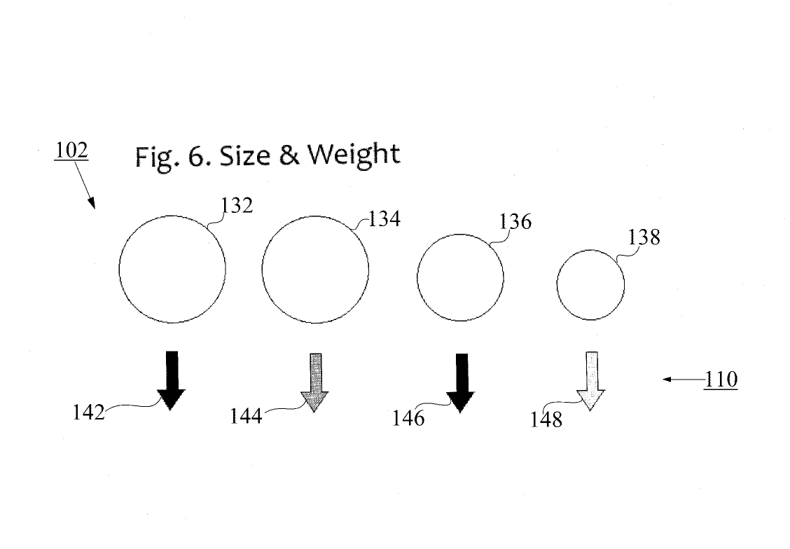

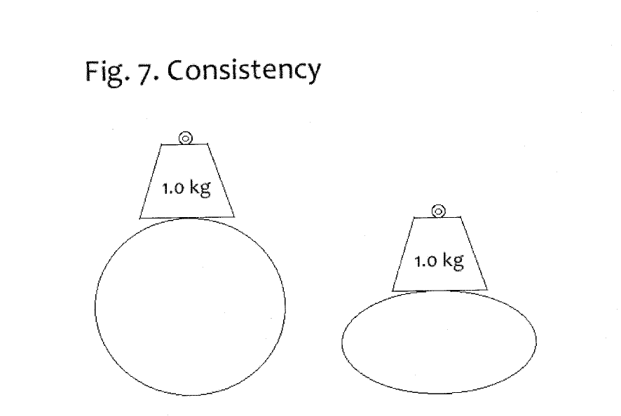

In an exemplary embodiment of the method of massage, the practitioner chooses a massage ball 100 of pre-selected sizes 102, such as 132, 134, 136, and 138, and weights 110, such as 142, 144, 146, and 148, as shown in FIG. 6. The practitioner places the massage ball 100 between the area to be massaged and the palm of the practitioner's hand 104. The ball 100 is then pushed into the area to be massaged using the palm 104 and moved in a circular motion 106, as in FIG. 5.

In one embodiment, the practitioner might select a massage ball 100 from among balls having a diameter 108 of about 2.0 cm to 15 cm and a pre-selected weight 110.

In an alternate embodiment, the massage ball 100 might be selected from among balls having a preselected diameter 108 but a range of weights 110 from about 10 grams to 200 grams.

Alternatively, the massage ball 100 might be selected from among balls having a diameter 108 from about 2.0 cm to 15 cm and a pre-selected weight 110, or from among balls having a weight 110 from about 10 grams to 200 grams and a pre-selected diameter 108.

In a preferred embodiment, the practitioner might first decide which area will be massaged and then choose a massage ball 100 of a preselected diameter 108 and weight 100, depending on which area they have elected to massage.

In an alternate embodiment, the practitioner might first decide to massage an area including the neck, face, hands, or feet, and then choose a massage ball 100 having a diameter 108 of less than 5 cm and a weight 110 of less than 60 grams.

It should be apparent to persons skilled in the arts that various modifications and adaptation of this structure described above are possible without departure from the spirit of the invention the scope of which defined in the appended claim.

I claim:

1. Method for massage therapy comprising:
a) Choosing a massage ball of pre-selected size and weight;
b) Use the massage ball by placing the ball between the area to be massaged; and the palm of hand;
c) Pushing the ball into the area to be massaged with the palm of a hand and moving the ball in a circular motion.

2. The method claimed in claim 1 wherein Step a is replaced with Step aa as follows:
aa) Choosing a massage ball from among balls having a diameter for about 2.0 cm to 15 cm and a pre-selected weight.

3. The method claimed in claim 1 wherein Step a is replaced with Step aa as follows:
aa) Choosing a massage ball from among balls having a weight from about 10 grams to 200 grams and a preselected diameter.

4. The method claimed in claim 1 wherein Step a is replaced with Step aa as follows:
aa) Choosing a massage ball from among balls having a diameter for about 2.0 cm to 15 cm and a pre-selected weight, choosing a massage ball from among balls having a weight from about 10 grams to 200 grams and a pre-selected diameter.

5. The method claimed in claim 1 further including the Step a′ and a″ replacing step a as follows:
a′) select an area to be messaged;
a″) choose a massage ball of pre-selected size and weight depending upon the area to be messaged.

6. The method claim 5, further including the step a″′ after step a″ as follows:
a″′) choose a ball having a diameter greater than 5 cm and a weight greater than 60 grams, for massage of the back.

7. The method claimed in claim 6, further including the step a″″ after step a″′ as follows:
a″″) choose a ball having a diameter less than 5 cm and a weight less than 60 grams for massage of the areas chosen from among neck, face, hands, and feet.

8. The method claimed in claim 1 further including the Step a′ and a″ replacing step a as follows:
a′) select a clothed area to be messaged;
a″) choose a massage ball of pre-selected size and weight to message the clothed area, wherein message takes place over the clothing;
